(19) United States
(12) Patent Application Publication
(10) Pub. No.: US 2005/0001095 A1
(43) Pub. Date: Jan. 6, 2005

(54) Self-aligning thrust reverser system lock assembly

(76) Inventor: Donald J. Christensen, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/754,748

(22) Filed: Jan. 8, 2004

Related U.S. Application Data
(60) Provisional application No. 60/468,314, filed on May 5, 2003.

(51) Int. Cl. B64C 7/00

(52) U.S. Cl. 244/110 B

(57) ABSTRACT

A lock assembly for a thrust reverser system that prevents thrust reverser movement, in either the deploy or stow directions, includes a lock bar and a lock that are configured to be self-aligning with respect to one another. This configuration ensures the lock assembly fully moves to the locked position even if the lock bar and lock are aligned with one another when the lock is being moved into the locked position.

### CROSS-REFERENCE TO RELATED APPLICATION

This application claims the benefit of U.S. Provisional Application No. 60/468,314 filed May 5, 2003.

### FIELD OF THE INVENTION

The present invention relates to aircraft engine thrust reverser actuation systems and, more particularly, to a self-aligning thrust reverser lock that will inhibit thrust reverser movement

### BACKGROUND OF THE INVENTION

When a jet-powered aircraft lands, the landing gear brakes and aerodynamic drag (e.g., flaps, spoilers, etc.) of the aircraft may not, in certain situations, be sufficient to slow the aircraft down in the required amount of runway distance. Thus, jet engines on most aircraft include thrust reversers to enhance the braking of the aircraft. When deployed, a thrust reverser redirects the rearward thrust of the jet engine to a generally or partially forward direction to decelerate the aircraft. Because at least some of the jet thrust is directed forward, the jet thrust also slows down the aircraft upon landing.

Various thrust reverser designs are commonly known, and the particular design utilized depends, at least in part, on the engine manufacturer, the engine configuration, and the propulsion technology being used. Thrust reverser designs used most prominently with jet engines fall into three general categories: (1) cascade-type thrust reversers; (2) target-type thrust reversers; and (3) pivot door thrust reversers. Each of these designs employs a different type of moveable thrust reverser component to change the direction of the jet thrust.

Cascade-type thrust reversers are can be used on high-bypass ratio jet engines. This type of thrust reverser is located on the circumference of the engine's midsection and, when deployed, exposes and redirects air flow through a plurality of cascade vanes. The moveable thrust reverser components in the cascade design includes several translating sleeves or cowls (“transcowls”) that are deployed to expose the cascade vanes.

Target-type reversers, also referred to as clamshell reversers, are typically used with low-bypass ratio jet engines. Target-type thrust reversers use two doors as the moveable thrust reverser components to block the entire jet thrust coming from the rear of the engine. These doors are mounted on the aft portion of the engine and may form the rear part of the engine nacelle.

Pivot door thrust reversers may utilize four doors on the engine nacelle as the moveable thrust reverser components. In the deployed position, these doors extend outwardly from the nacelle to redirect the jet thrust.

The primary use of thrust reversers is, as noted above, to enhance the braking of the aircraft, thereby shortening the stopping distance during landing. Hence, thrust reversers are usually deployed during the landing process to slow the aircraft. Thereafter, when the thrust reversers are no longer needed, they are returned to their original, or stowed, position and are locked.

Each of the above-described thrust reverser system designs may include one or more locks to inhibit unintended thrust reverser movement and/or movement of the actuator assemblies that move the thrust reversers. In some instances, the locks that are used are relatively large and heavy, include numerous parts that can potentially wear out, and may include relatively complex actuation mechanisms or may rely on special tools to operate the lock manually.

Hence, there is a need for a lock assembly for a thrust reverser system that is small, and/or lightweight, and/or relatively easy to use, and/or does not rely on special tools to operate manually. The present invention addresses one or more of these needs.

### SUMMARY OF THE INVENTION

The present invention relates to a lock assembly and a thrust reverser system with one or more lock assemblies. The lock assembly includes a lock bar and a lock that are configured to be self-aligning with respect to one another, which ensures the lock assembly fully moves to the locked position even if the lock bar and lock are aligned with one another when the lock is being moved into the locked position.

In one embodiment, and by way of example only, a thrust reverser actuation system includes a power drive unit, an actuator assembly, and a lock assembly. The power drive unit is operable to supply a drive force. The actuator assembly is coupled to receive the drive force and is operable to move, upon receipt of the drive force, between a stowed position and a deployed position. The lock assembly is coupled to the actuator assembly and includes a housing, a lock bar, a lock, and a lock spring. The lock bar is coupled to receive the drive force and is configured, upon receipt thereof, to rotate. The lock bar includes an outer surface that is at least partially rounded. The lock has one or more lock pins extending therefrom, each having an end that is at least partially rounded. The lock is mounted within the housing and is moveable between at least a locked position, in which each lock pin at least selectively engages at least one lock bar protrusion to thereby at least limit rotational movement thereof, and an unlocked position, in which each lock pin is disengaged from each lock bar protrusion to thereby allow rotational movement thereof. The lock spring is mounted in the housing and is coupled to the lock. The lock spring is configured to bias each lock pin toward the unlocked position and to allow rotation of the lock pins.

In another exemplary embodiment, a thrust reverser lock assembly includes a housing, a lock bar, a lock, and a lock spring. The lock bar is adapted to receive a drive force and is configured, upon receipt thereof, to rotate. The lock bar includes an outer surface that is at least partially rounded. The lock has one or more lock pins extending therefrom, each having an end that is at least partially rounded. The lock is mounted within the housing and is moveable between at least a locked position, in which each lock pin at least selectively engages at least one lock bar protrusion to thereby at least limit rotational movement thereof, and an unlocked position, in which each lock pin is disengaged from each lock bar protrusion to thereby allow rotational movement thereof. The lock spring is mounted in the housing and is coupled to the lock. The lock spring is configured to bias each lock pin toward the unlocked position and to allow rotation of the lock pins.

In still another exemplary embodiment, a thrust reverser actuator assembly includes a housing, a drive shaft, and a lock assembly. The drive shaft is rotationally mounted in the housing. The lock assembly includes a housing, a lock bar, a lock, and a lock spring. The lock bar is coupled to the drive shaft and is configured to rotate therewith. The lock bar includes an outer surface that is at least partially rounded. The lock has one or more lock pins extending therefrom, each having an end that is at least partially rounded. The lock is mounted within the housing and is moveable between at least a locked position, in which each lock pin at least selectively engages at least one lock bar protrusion to thereby at least limit rotational movement thereof, and an unlocked position, in which each lock pin is disengaged from each lock bar protrusion to thereby allow rotational movement thereof. The lock spring is mounted in the housing and is coupled to the lock. The lock spring is configured to bias each lock pin toward the unlocked position and to allow rotation of the lock pins.

Other independent features and advantages of the preferred actuation system, actuator, and lock assembly will become apparent from the following detailed description, taken in conjunction with the accompanying drawings which illustrate, by way of example, the principles of the invention.

### BRIEF DESCRIPTION OF THE DRAWINGS

FIG. 1 is a perspective view of portions of an aircraft jet engine fan case;

FIG. 2 is a simplified end view of a thrust reverser actuation system according to an exemplary embodiment of the present invention;

FIG. 3 is a cross section view of an actuator assembly that may be used in the thrust reverser actuation system of FIG. 2;

FIG. 4 is a close-up perspective view of the actuator assembly shown in FIG. 2, which shows an exemplary embodiment of a lock assembly coupled thereto in accordance with the present invention;

FIG. 5 is a perspective exploded view of the exemplary lock assembly shown in FIG. 4;

FIG. 6 is a close-up perspective view of a portion of the lock assembly shown in FIG. 4;

FIG. 7 is a cross section view of the lock assembly of FIG. 4;

FIG. 8 is a close-up, partial exploded view of a portion of the lock assembly of FIG. 4; and

FIG. 9 is an end view of a portion of the lock assembly of FIG. 4.

### DETAILED DESCRIPTION OF A PREFERRED EMBODIMENT

Before proceeding with the detailed description, it is to be appreciated that the described embodiment is not limited to use in conjunction with a specific thrust reverser system design. Thus, although the description is explicitly directed toward an embodiment that is implemented in a cascade-type thrust reverser system, in which transcowls are used as the moveable thrust reverser component, it should be appreciated that it can be implemented in other thrust reverser actuation system designs, including those described above and those known now or hereafter in the art.

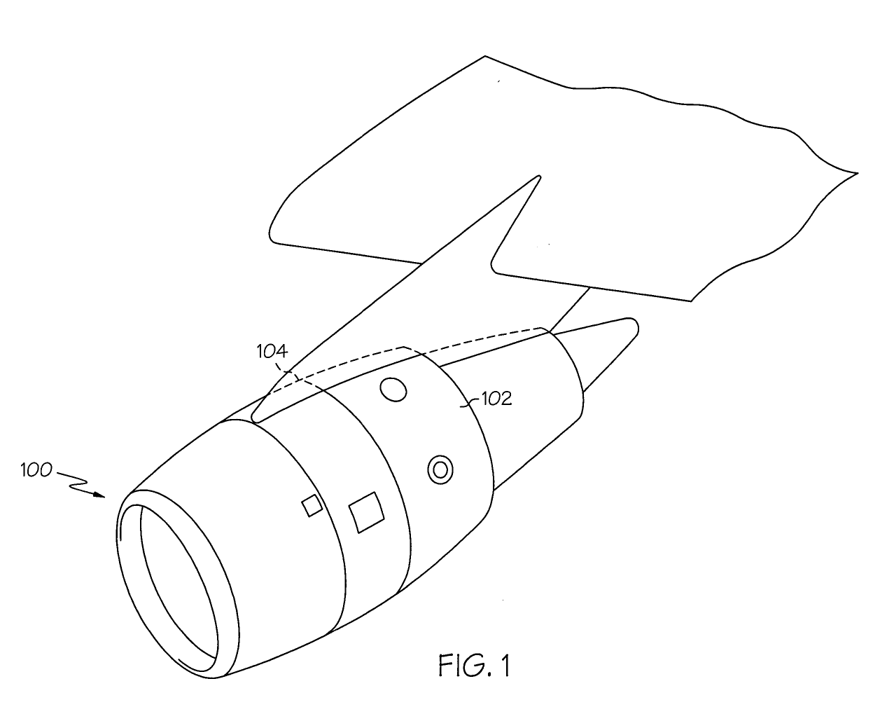

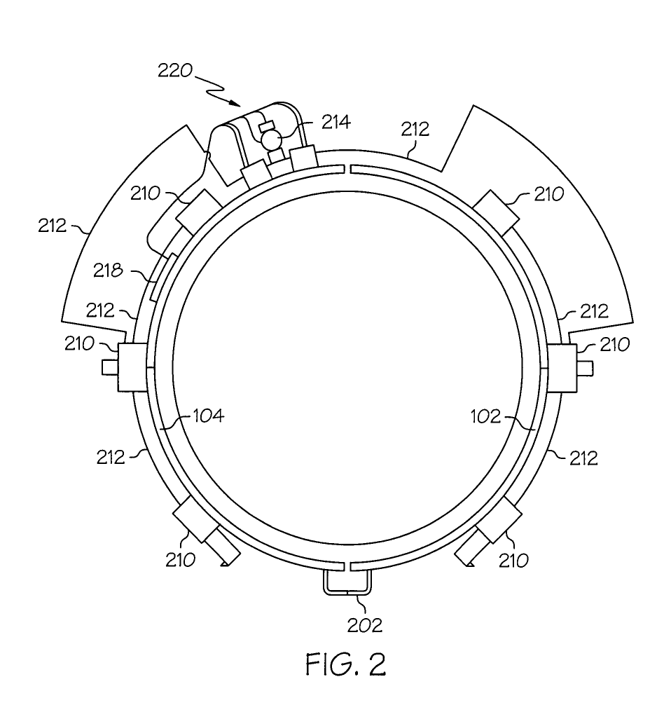

Turning now to the description, and with reference first to FIG. 1, a perspective view of portions of an aircraft jet engine fan case 100 that incorporates a cascade-type thrust reverser is depicted. The engine fan case 100 includes a pair of semi-circular transcowls 102 and 104 that are positioned circumferentially on the outside of the fan case 100. The transcowls 102 and 104 cover a plurality of non-illustrated cascade vanes. A mechanical link 202 (see FIG. 2), such as a pin or latch, may couple the transcowls 102 and 104 together to maintain the transcowls 102 and 104 in correct alignment on non-illustrated guides on which the transcowls 102 and 104 translate. When the thrust reversers are commanded to deploy, the transcowls 102 and 104 are translated aft. This, among other things, exposes the cascade vanes, and causes at least a portion of the air flowing through the engine fan case 100 to be redirected in a forward direction. This re-direction of air flow in a forward direction creates a reverse thrust and, thus, works to slow the airplane upon landing.

As shown more clearly in FIG. 2, the thrust reverser system 200 includes a plurality of actuator assemblies 210 that are individually coupled to the transcowls 102 and 104. In the depicted embodiment, half of the actuator assemblies 210 are coupled to one of the transcowls 102, and the other half are coupled to another transcowl 104. One or more of the actuator assemblies 210 may include a lock, which is described in detail further below, some or all of which may include a position sensor. In addition, each of the transcowls 102 and 104 may also have a lock. It is noted that the number and arrangement of the actuator assemblies 210 is not limited to what is depicted in FIG. 2, but could include other numbers of actuator assemblies 210 as well. The number and arrangement of actuator assemblies and locks is selected to meet the specific design requirements of the system and can be varied.

The actuator assemblies 210 are interconnected via a plurality of drive mechanisms 212, each of which, in the particular depicted embodiment, is a flexible shaft. The flexible shafts 212 in this configuration are driven to ensure that the actuator assemblies 210 and the transcowls 102 and 104 move in a substantially synchronized manner. For example, when one transcowl 102 is moved, the other transcowl 104 is moved a like distance at substantially the same time. Other synchronization mechanisms may be used including, but not limited to, electrical synchronization or open loop synchronization, or any other mechanism or design that transfers power between the actuator assemblies 210.

A power drive unit (PDU) assembly 220 is coupled to the actuator assemblies 210 via one or more flexible shafts 212. In the depicted embodiment, the PDU assembly 220 includes a dual output motor 214 that is coupled to two of the flexible shafts 212. The motor 214 may be any one of numerous types of motors such as, for example, an electric (including any one of the various DC or AC motor designs known in the art), a hydraulic, or a pneumatic motor. Though not explicitly depicted, it should be understood that the PDU assembly 220 may include a lock mechanism. It should additionally be understood that the system could be configured with two or more PDU assemblies 220, one per transcowl 102 and 104, rather than a single PDU assembly 220. In any case, with the depicted arrangement, the rotation of the PDU assembly 220 results in the synchronous operation of the actuator assemblies 210, via the flexible shafts 212, thereby causing the transcowls 102 and 104 to move at substantially the same rate.

The PDU assembly 220 is controlled by a control circuit 218. The control circuit 218 receives commands from a non-illustrated engine control system such as, for example, a FADEC (full authority digital engine control) system, and provides appropriate activation signals to the PDU assembly 220 in response to the received commands. In turn, the PDU assembly 220 supplies a drive force to the actuator assemblies 210 via the flexible shafts 212. As a result, the actuator assemblies 210 cause the transcowls 102 and 104 to translate between the stowed and deployed positions. In the depicted embodiment, the PDU assembly 220 supplies the drive force, via individual flexible shafts 212, to one of the actuator assemblies 210 associated with each transcowl 102, 104. The drive force is then coupled to the other actuator assemblies 210 associated with each transcowl 102, 104 via the remaining flexible shafts 212.

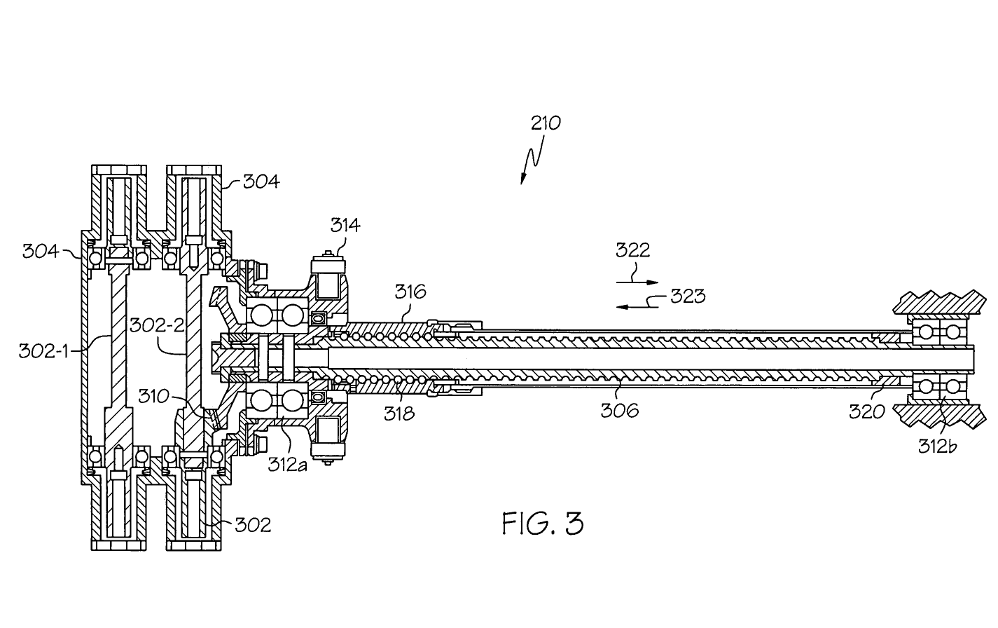

The actuator assemblies 210 used in the thrust reverser system 200 may be any one of numerous actuator designs presently known in the art or hereafter designed. However, in the depicted embodiment the actuator assemblies 210 are ballscrew type actuator assemblies. An exemplary embodiment of one of the actuator assemblies 210 is shown in FIG. 3 and, for completeness of understanding, will now be discussed. The actuator assembly 210 depicted in FIG. 3 is one of those to which the PDU assembly 220 is coupled. Thus, in the depicted embodiment, the actuator assembly 210 includes two drive shafts, an input drive shaft 302-1, and an output drive shaft 302-2, both of which are mounted in an actuator assembly housing 304, and a ball screw shaft 306 that extends through the actuator assembly housing 304.

The drive shafts 302-1, 302-2 are each adapted to couple to one or more of the flexible shafts 212 (not shown in FIG. 3) or, as will be described more fully below, to a lock assembly. In the depicted embodiment, the input drive shaft 302-1, when installed in the thrust reverser system 200, is coupled to one of the flexible shafts 212, in particular one of the flexible shafts 212 that is coupled to the PDU assembly 220, and is also coupled to a lock assembly (not shown in FIG. 3). The output drive shaft 302-2, when installed in the thrust reverser system 200, is coupled to two of the flexible shafts 212. The input 302-1 and output 302-2 drive shafts are coupled together via a pair of first gears (not shown), and the output drive shaft 302-2 is coupled to the ball screw shaft 306 via a second gear 310.

The ball screw shaft 306 is rotationally supported by a first duplex bearing assembly 312a. One end of the ball screw shaft 306 is connected, via a gimbal mount 314, to the forward end of the engine nacelle support (not illustrated). Another end of the ball screw shaft 306 is rotationally supported by a second duplex bearing assembly 312b, which is connected to the aft end of an engine nacelle support (not illustrated). A ball nut 316, which is rotationally supported on the ball screw shaft 306 by a plurality of ball bearings 318, is attached to one of the transcowls 102 or 104 (not illustrated in FIG. 3). Thus, rotation of the ball screw shaft 306 results in translation of the ball nut 316 and transcowl 102 or 104. A mechanical hard stop 320, positioned near the second duplex bearing assembly 312b, stops translation of the ball nut 316, and thus the attached transcowl 102 or 104, when it is moved in the deploy direction 322.

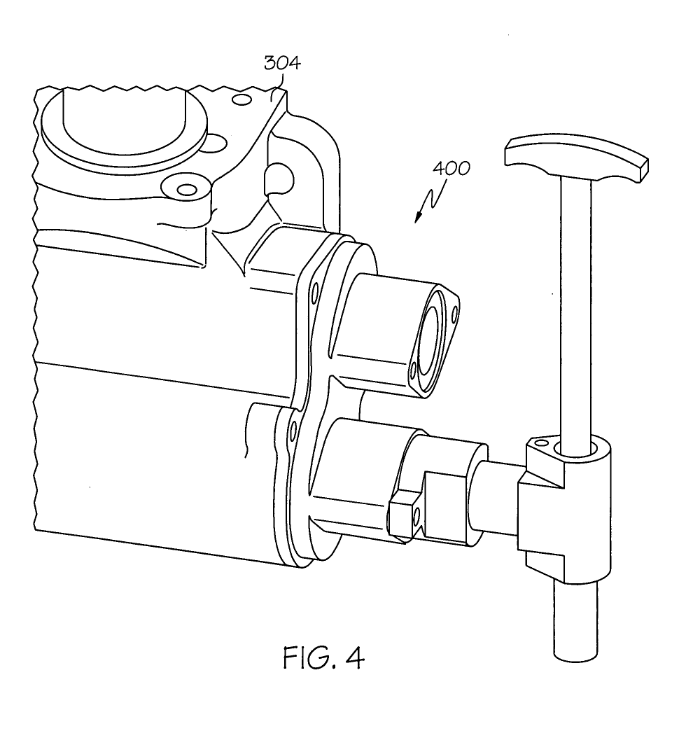

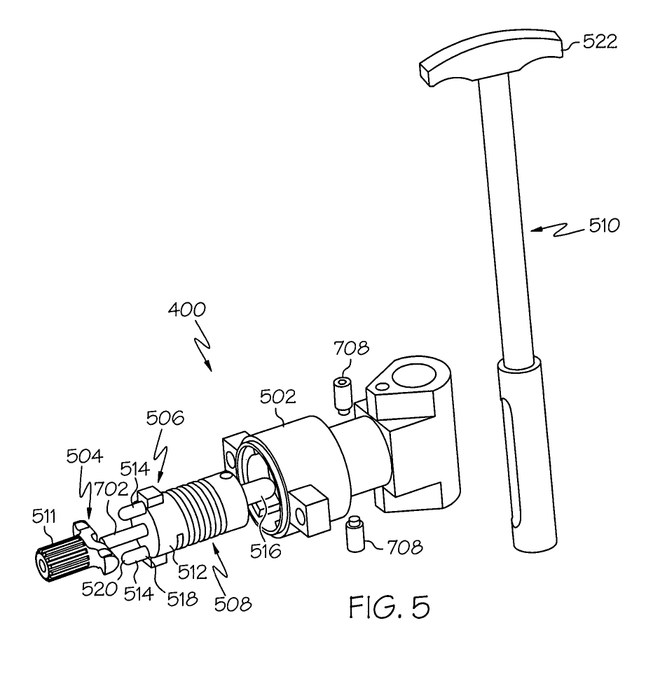

As was previously noted, the actuator assembly 210 preferably includes a lock assembly to prohibit unintended movement of the actuator assembly 210, and thus unintended thrust reverser movement. In the embodiment, and as shown more clearly in FIG. 4, a lock assembly 400 is coupled to the actuator assembly housing 304. A more detailed illustration of an exemplary embodiment of the lock assembly 400 is shown in FIGS. 5-8, and will now be described in detail.

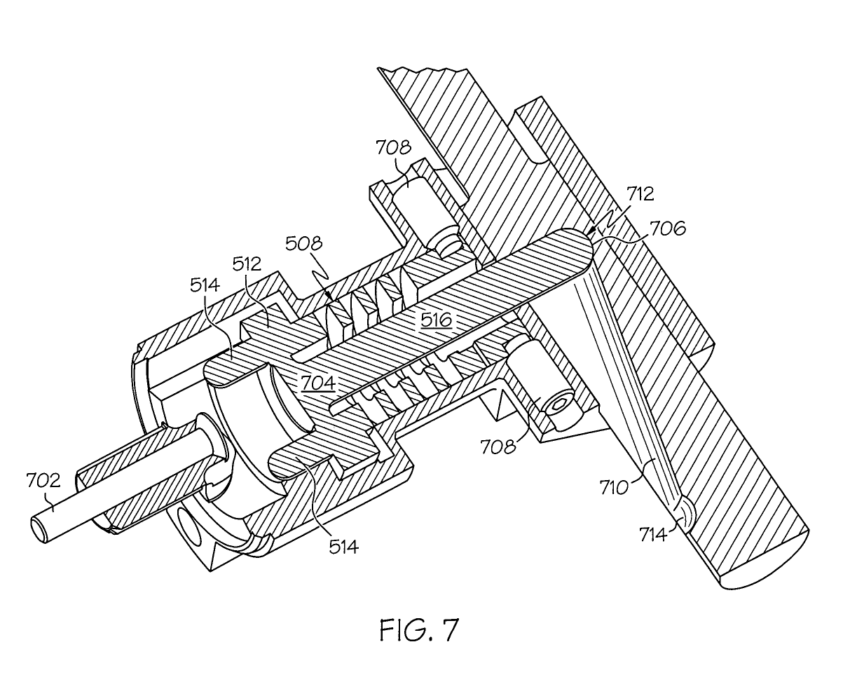

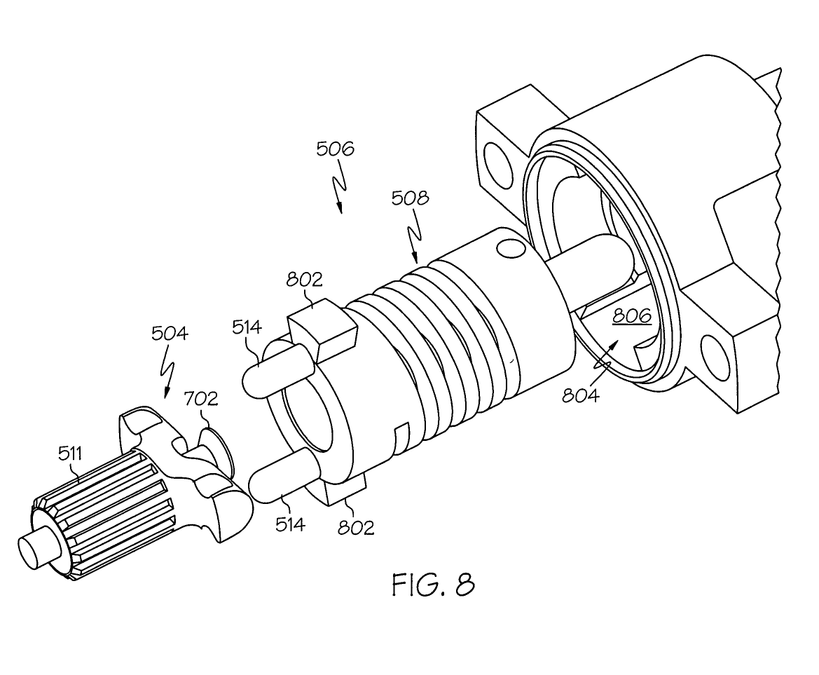

With reference first to FIG. 5, it is seen that the lock assembly 400 includes a housing 502, a lock bar 504, a lock 506, a lock spring 508, and a lock actuator handle 510. In the depicted embodiment, the lock bar 504 is adapted to couple to the actuator assembly input drive shaft 302-1. Thus, the lock bar 504, upon receipt of the drive force from the PDU assembly 220, rotates with the input drive shaft 302-1. Preferably, the lock bar 504 is coupled to the input drive shaft 302-1 via a spline shaft 511 and, as shown more clearly in FIGS. 7 and 8, a threaded fastener 702. It will be appreciated, however, that the lock bar 504 could be coupled to the actuator assembly input drive shaft 302-1 in any one of numerous other ways, or it could be formed integrally with the actuator assembly input drive shaft 302-1.

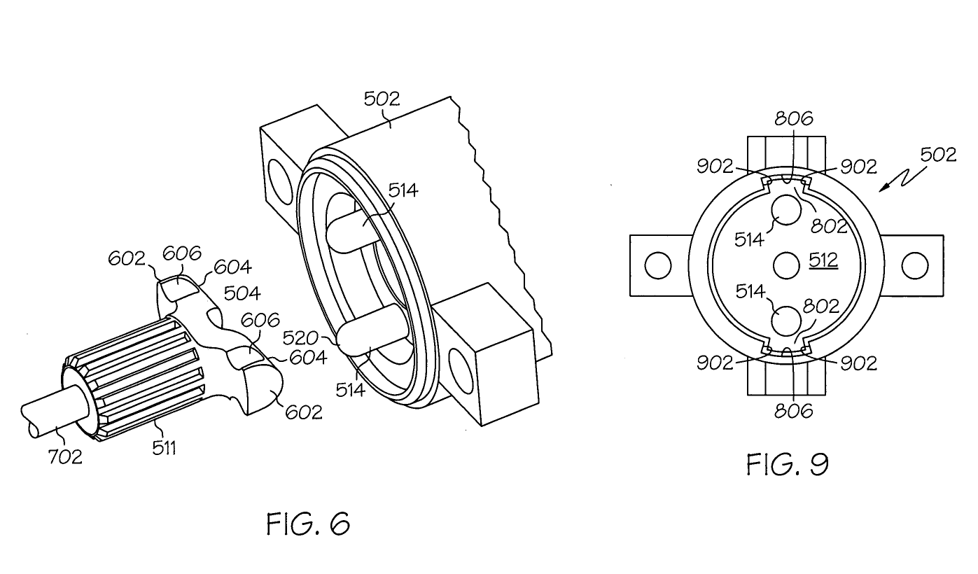

Turning now to FIG. 6, it is seen that the lock bar 504 includes a plurality of protrusions 602, each having an outer surface 604 that is at least partially rounded. Each of the protrusions 602 additionally includes one or more indentations 606 formed in the outer surface 604. The purpose for the rounded outer surface 604 and the indentations 606 formed therein will be discussed further below. Although the lock bar 504 in the depicted embodiment has two protrusions 602, it will be appreciated that the lock bar 504 could include more or less than this number of protrusions 602. Indeed, in one embodiment the protrusions 602 are configured similar to a multi-toothed gear, in which each gear tooth would include the at least partially rounded outer surface 604, and may additionally include the indentations 606, if desired.

Returning once again to FIG. 5, the lock 506 is mounted within the housing 502 and includes a main body 512, a plurality of lock pins 514, and an actuation rod 516. Each of the lock pins 514 is coupled to the main body 512 via a first end 518, and has a second end 520 that extends away from the main body 512. Similar to the lock bar protrusion outer surfaces 604, and as is once again shown more clearly in FIG. 6, each lock pin second end 520 is at least partially rounded. As with the lock bar protrusion outer surfaces 604, the purpose for the rounded lock pin second ends 520 will be discussed further below. Moreover, similar to the lock bar protrusions 602, although the lock 506 is depicted as including two lock pins 514, it will be appreciated that the lock 506 could include more or less than this number of lock pins 514, and could be configured similar to a multi-toothed gear that mates with similarly configured lock bar protrusions 602, as was alluded to above. The lock actuation rod 516, which can be seen most clearly in FIG. 7, is coupled to the lock main body 512 via a first end 704, and extends away from the main body 512, through the lock spring 508, to a second end 706. The actuation rod second end 706 engages the lock actuator handle 510, which is described more fully further below.

The lock spring 508, which is also mounted in the housing 502, is coupled to the lock main body 512. In particular, and with continued reference to FIG. 7, it is seen that the lock spring 508 is mounted in the housing 502 using a plurality of setscrews 708. It will be appreciated that the use of setscrews 708 is merely exemplary of a particular preferred embodiment, and that other fasteners could be used, or the spring 508 could be formed integrally with the housing 502. Moreover, the spring 508 is preferably formed integrally with the lock 506, though it could be formed separate from the lock 506, and then coupled to the lock 506 using one or more fasteners or by brazing or welding.

No matter how the lock spring 508 is coupled to the lock 506, the lock spring 508 is preferably a machined, bidirectional torsion spring that is configured to bias the lock 506, and thus the lock pins 514, away from the lock bar 504, which is the unlocked position. The lock spring 508 is also configured, by way of the mounting configuration described above, to allow bidirectional rotation of the lock 506, and thus the lock pins 514. The purpose for allowing rotation of the lock 506 and lock pins 514 will be discussed further below. Although the lock spring 508 is preferably a machined torsion spring, it will be appreciated that it could be a coil spring, or any one of numerous other mechanisms that supply a bias force and allow at least limited rotation of the lock 506 relative to the housing 502.

The lock actuator handle 510 is used to move the lock 506 between a locked position and an unlocked position. To do so, the lock actuator handle 510, as shown in FIG. 7, includes an internal groove 710 that has an unlock detent 712 on one end, and a lock detent 714 on another end. The lock actuator handle 510 is shown in the unlock position in FIG. 7, and in this position the lock actuation rod second end 706 is disposed within the unlock detent 712, which helps hold the handle 510 in position. To move the lock 506 into the locked position, the lock actuator handle 510 is pulled upwardly, with reference to the views in FIGS. 4, 5, and 7, using a manual grip 522 (see FIG. 5). As the handle 510 moves upwardly, the internal groove 710, which is ramped, pushes the actuation rod 516 toward the lock position, against the bias force of the spring 508. When the handle 510 is pulled to the fully locked position, the actuation rod second end 706 is disposed within the lock detent 714, which helps hold the handle in the locked position.

It will be appreciated that the configuration of the lock actuator handle 510 depicted and described herein is merely exemplary of a particular preferred embodiment, and that other configurations could also be used. For example, the handle 510 could be configured to rotate, rather than translate, between the locked and unlocked positions. It will additionally be appreciated that a non-manual type of lock actuator could be used. For example, a solenoid, motor, or piston, which could be locally or remotely controlled, could be used to move the lock 506 between the unlocked and locked positions.

During operation of the thrust reverser system 200, the PDU 220 supplies a drive force to the actuator assemblies 210, which in turn move between stowed and deployed positions, to thereby move the transcowls 102, 104 between the stowed and deployed positions. As was mentioned above, upon receipt of the drive force, the actuator assembly input drive shaft 302-1 rotates, and thus the lock bar 504 also rotates. When it is desired to engage the lock 506, lock actuator handle 510 is moved to the lock position, which causes the lock actuation rod 516, and thus the lock 506 and lock pins 514, to translate toward the locked position, against the bias force of the lock spring 508. Because the lock bar 504 rotates with the input drive shaft 302-1, the lock bar protrusions 602 may be aligned with the lock pins 514 in the locked position, causing the lock pin second ends 520 to contact the lock bar protrusions 602. However, as will now be discussed, the above described configuration of the lock assembly 400 allows the lock 506 to rotate a sufficient amount to allow the lock pins 514 to appropriately engage the lock bar protrusions 602 and prevent (or at least limit) actuator assembly 210 movement.

As was previously mentioned, the lock bar protrusions 602 each have an outer surface 604 that is at least partially rounded, and one or more indentations 606 formed in the outer surface 604. It was additionally mentioned above that each of the lock pin second ends 520 is at least partially rounded, and that the lock Spring 508 is configured to allow rotation of the lock 506 and thus the lock pins 514. Thus, if the lock bar protrusions 602 are aligned with the lock pins 514 when the lock 506 is moved to the locked position, the rounded protrusion outer surface 604 and rounded lock pin second ends 520, in conjunction with the lock spring 508, allow the lock 506 to rotate slightly, and the lock pins 514 to slide to one side of each of the lock bar protrusions 602, to thereby move into the locked position, and into physical contact with the lock bar indentations 606.

With reference now to FIGS. 8 and 9, it is seen that the lock 506 additionally includes a plurality of engagement lugs 802 that extend from the main body 512. In addition, the lock assembly housing 502 includes a plurality of lock stops 804. In the depicted embodiment, the lock stops 804 are each formed as a cavity on an inner surface 806 of the housing 502, though it will be appreciate that the lock stops 804 could be formed in any one of numerous other ways and configurations. As can be seen most clearly in FIG. 9, the lock stops 804 each include a plurality of engagement surfaces 902. The engagement lugs 802 and the lock stop engagement surfaces 902 are preferably configured such that, at least when the lock 506 is in the unlocked position, the engagement lugs 802 are spaced apart from the lock stop engagement surfaces 902, and the lock spring 508 substantially centers the engagement lugs 802 between the lock stop engagement surfaces 902. With this configuration, any rotation of the lock 506 is limited to the clearance distance between the engagement lugs 802 and the lock stop engagement surfaces 902. Such a limit on rotational movement of the lock 506 is desirable to, among other things, limit the stress on the lock spring 508. In addition, the lock spring 508 returns the lock 506 to the centered position when the lock 506 is moved out of the locked position.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An aircraft thrust reverser control system, comprising:
a power drive unit operable to supply a drive force;
an actuator assembly coupled to receive the drive force and operable to move, upon receipt of the drive force, between a stowed position and a deployed position; and
a lock assembly coupled to one of the power drive unit and the actuator assembly, the lock assembly including:
a housing,
a lock bar coupled to receive the drive force and configured, upon receipt thereof, to rotate, the lock bar including an outer surface that is at least partially rounded,
a lock having one or more lock pins extending therefrom, each lock pin having an end that is at least partially rounded, the lock mounted within the housing and moveable between at least (i) a locked position, in which each lock pin at least selectively engages at least one lock bar protrusion to thereby at least limit rotational movement thereof, and (ii) an unlocked position, in which each lock pin is disengaged from each lock bar protrusion to thereby allow rotational movement thereof, and
a lock spring mounted in the housing and coupled to the lock, the lock spring configured to (i) bias each lock pin toward the unlocked position and (ii) allow rotation of the lock pins.

2. The system of claim 1, wherein the lock bar comprises one or more protrusions, each protrusion including the at least partially rounded outer surface, and one or more indentations formed, each indentation configured to receive a lock pin therein when the lock is in the locked position.

3. The system of claim 1, further comprising:
one or more lock stops coupled to the housing and configured to limit the rotation of the lock.

4. The system of claim 3, further comprising:
one or more engagement lugs coupled to, and extending from, the lock, each engagement lug disposed proximate at least one of the lock stops and configured to engage at least one of the lock stops, upon rotation of the lock a predetermined amount.

5. The system of claim 1, further comprising:
one or more fastener openings extending through the lock assembly housing; and
one or more fasteners, each fastener disposed within one of the fastener openings and coupled to the lock spring.

6. The system of claim 1, further comprising:
an actuation rod having at least a first end and a second end, the actuation rod first end coupled to the lock, and the actuation rod second end extending through the lock spring; and
a lock actuator coupled to the lock assembly housing and disposed at least proximate the actuation rod second end, the lock actuator configured to at least selectively engage the actuation rod second end to thereby move the actuation rod, and thus the lock, between the locked and unlocked positions.

7. The system of claim 6, wherein the lock actuator comprises:
a rod extending at least partially through the lock assembly housing;
a cavity formed in the rod, the cavity extending from an opening to a bottom surface, the bottom surface having a first end and a second end, the bottom surface first end disposed a first distance from the cavity opening and the bottom surface second end disposed a second distance from the cavity opening,
wherein the lock actuation rod extends into the cavity and contacts the cavity bottom surface.

8. The system of claim 1, wherein the lock spring is a bidirectional torsion spring.

9. The system of claim 1, wherein the actuator assembly includes a drive shaft having a spline receptacle formed therein, and wherein the lock assembly further includes:
a spline shaft coupled to the lock bar and disposed at least partially within the spline receptacle.

10. The system of claim 1, wherein the lock assembly housing includes an inner surface, and wherein the lock assembly further includes:
one or more cavities formed on the housing assembly inner surface, each cavity having at least two side walls;
one or more engagement lugs coupled to, and extending from, the lock, each engagement lug disposed at least partially within one of the cavities, and configured to engage at least one of the cavity sidewall upon rotation of the lock a predetermined amount.

11. A thrust reverser system lock assembly, comprising:
a housing,
a lock bar coupled to receive adapted to receive a drive force and configured, upon receipt thereof, to rotate, the lock bar including an outer surface that is at least partially rounded,
a lock having one or more lock pins extending therefrom, each lock pin having an end that is at least partially rounded, the lock mounted within the housing and moveable between at least (i) a locked position, in which each lock pin at least selectively engages at least one lock bar protrusion to thereby at least limit rotational movement thereof, and (ii) an unlocked position, in which each lock pin is disengaged from each lock bar protrusion to thereby allow rotational movement thereof, and
a lock spring mounted in the housing and coupled to the lock, the lock spring configured to (i) bias each lock pin toward the unlocked position and (ii) allow rotation of the lock pins.

12. The lock of claim 11, wherein the lock bar comprises one or more protrusions, each protrusion including the at least partially rounded outer surface, and one or more indentations formed, each indentation configured to receive a lock pin therein when the lock is in the locked position.

13. The lock of claim 11, further comprising:
one or more lock stops coupled to the housing and configured to limit the rotation of the lock.

14. The lock of claim 13, further comprising:
one or more engagement lugs coupled to, and extending from, the lock, each engagement lug disposed proximate at least one of the lock stops and configured to engage at least one of the lock stops, upon rotation of the lock a predetermined amount.

15. The lock of claim 11, further comprising:
one or more fastener openings extending through the lock assembly housing; and
one or more fasteners, each fastener disposed within one of the fastener openings and coupled to the lock spring.

16. The lock of claim 11, further comprising:
an actuation rod having at least a first end and a second end, the actuation rod first end coupled to the lock, and the actuation rod second end extending through the lock spring; and
a lock actuator coupled to the lock assembly housing and disposed at least proximate the actuation rod second end, the lock actuator configured to at least selectively engage the actuation rod second end to thereby move the actuation rod, and thus the lock, between the locked and unlocked positions.

17. The lock of claim 16, wherein the lock actuator comprises:
a rod extending at least partially through the lock assembly housing;
a cavity formed in the rod, the cavity extending from an opening to a bottom surface, the bottom surface having a first end and a second end, the bottom surface first end disposed a first distance from the cavity opening and the bottom surface second end disposed a second distance from the cavity opening,
wherein the lock actuation rod extends into the cavity and contacts the cavity bottom surface.

18. The lock of claim 11, wherein the lock spring is a bidirectional torsion spring.

19. The lock of claim 11, further comprising:
a spline shaft coupled to the lock bar.

20. The lock of claim 11, wherein the lock assembly housing includes an inner surface, and wherein the lock assembly further includes:
one or more cavities formed on the housing assembly inner surface, each cavity having at least two side walls;
one or more engagement lugs coupled to, and extending from, the lock, each engagement lug disposed at least partially within one of the cavities, and configured to engage at least one of the cavity sidewall upon rotation of the lock a predetermined amount.

21. A thrust reverser actuator assembly, comprising:
a housing;
a drive shaft rotationally mounted at least partially within the housing and configured to rotate in a deploy direction and a stow direction; and
a lock assembly coupled to the housing, the lock assembly including:
a housing,
a lock bar coupled to the drive shaft and configured to rotate therewith, the lock bar including an outer surface that is at least partially rounded,
a lock having one or more lock pins extending therefrom, each lock pin having an end that is at least partially rounded, the lock mounted within the housing and moveable between at least (i) a locked position, in which each lock pin at least selectively engages at least one lock bar protrusion to thereby at least limit rotational movement thereof, and (ii) an unlocked position, in which each lock pin is disengaged from each lock bar protrusion to thereby allow rotational movement thereof, and
a lock spring mounted in the housing and coupled to the lock, the lock spring configured to (i) bias each lock pin toward the unlocked position and (ii) allow rotation of the lock pins.

22. The actuator assembly of claim 21, wherein the lock bar comprises one or more protrusions, each protrusion including the at least partially rounded outer surface, and one or more indentations formed, each indentation configured to receive a lock pin therein when the lock is in the locked position.

23. The actuator assembly of claim 21, further comprising:
one or more lock stops coupled to the housing and configured to limit the rotation of the lock.

24. The actuator assembly of claim 23, further comprising:
one or more engagement lugs coupled to, and extending from, the lock, each engagement lug disposed proximate at least one of the lock stops and configured to engage at least one of the lock stops, upon rotation of the lock a predetermined amount.

25. The actuator assembly of claim 21, further comprising:
one or more fastener openings extending through the lock assembly housing; and
one or more fasteners, each fastener disposed within one of the fastener openings and coupled to the lock spring.

26. The actuator assembly of claim 21, further comprising:
an actuation rod having at least a first end and a second end, the actuation rod first end coupled to the lock, and the actuation rod second end extending through the lock spring; and
a lock actuator coupled to the lock assembly housing and disposed at least proximate the actuation rod second end, the lock actuator configured to at least selectively engage the actuation rod second end to thereby move the actuation rod, and thus the lock, between the locked and unlocked positions.

27. The actuator assembly of claim 25, wherein the lock actuator comprises:
a rod extending at least partially through the lock assembly housing;
a cavity formed in the rod, the cavity extending from an opening to a bottom surface, the bottom surface having a first end and a second end, the bottom surface first end disposed a first distance from the cavity opening and the bottom surface second end disposed a second distance from the cavity opening,
wherein the lock actuation rod extends into the cavity and contacts the cavity bottom surface.

28. The actuator assembly of claim 21, wherein the lock spring is a bidirectional torsion spring.

29. The actuator assembly of claim 21, wherein the drive shaft includes a spline receptacle formed therein, and wherein the lock assembly further includes:
a spline shaft coupled to the lock bar and disposed at least partially within the spline receptacle.

30. The actuator assembly of claim 21, wherein the lock assembly housing includes an inner surface, and wherein the lock assembly further includes:
one or more cavities formed on the housing assembly inner surface, each cavity having at least two side walls;
one or more engagement lugs coupled to, and extending from, the lock, each engagement lug disposed at least partially within one of the cavities, and configured to engage at least one of the cavity sidewall upon rotation of the lock a predetermined amount.
